(19) United States
(12) Patent Application Publication
(10) Pub. No.: US 2026/0329519 A1
(43) Pub. Date: Oct. 22, 2026

(54) IN-VEHICLE SYSTEM, VEHICLE, AND INFORMATION PROCESSING APPARATUS

(71) Applicant: TOYOTA JIDOSHA KABUSHIKI KAISHA, Toyota-shi (JP)

(72) Inventors: Seiichi TANAKA, Toyota-shi (JP); Junichi TODAKA, Seto-shi (JP); Kanako MATSUMOTO, Tokyo (JP); Akinori SHIN, Toyota-shi (JP); Sara YAMAFUJI, Miyoshi-shi (JP); Kazuyuki SHIGA, Nisshin-shi (JP); Yu YOKOYAMA, Ogaki-shi (JP); Yasuhiro KOBATAKE, Nagoya-shi (JP)

(73) Assignee: TOYOTA JIDOSHA KABUSHIKI KAISHA, Toyota-shi (JP)

(21) Appl. No.: 19/643,415

(22) Filed: Apr. 9, 2026

(30) Foreign Application Priority Data
Apr. 16, 2025 (JP) 2025-067726

(51) Int. Cl. G06F 3/14; B60K 35/10; B60K 35/22; B60K 35/29

(52) U.S. Cl. CPC G06F 3/1454; B60K 35/10; B60K 35/22; B60K 35/29; G06F 3/1423; B60K 2360/1434; B60K 2360/186

(57) ABSTRACT

An information processing apparatus includes a control unit configured to control a display apparatus including a pair of first display units and a second display unit. The first display units, each having a touch panel, are respectively disposed on both sides of a steering wheel while projecting rearward of a vehicle beyond an instrument panel in front of a driver seat in a cabin and directly ahead of the steering wheel. The second display unit is disposed at an intermediate location between the driver seat and a front passenger seat in a front region of the cabin. The control unit is configured to, when an input operation performed by a user on one of the first display units is detected by the touch panel, mirror a screen displayed on one of the first display units, on which the input operation is performed, onto the second display unit.

### CROSS-REFERENCE TO RELATED APPLICATION

This application claims priority to Japanese Patent Application No. 2025-067726 filed on Apr. 16, 2025. The disclosure of the above-identified application, including the specification, drawings, and claims, is incorporated by reference herein in its entirety.

### BACKGROUND

### 1. Technical Field

The disclosure relates to an in-vehicle system, a vehicle, and an information processing apparatus.

### 2. Description of Related Art

There is known a vehicle that includes a steering wheel, a center display unit provided in front of the steering wheel, and a side display unit provided on one or both sides of the center display unit in the vehicle width direction (see, for example, Japanese Patent No. 7306210 (JP 7306210 B)).

### SUMMARY

The disclosure improves convenience for a user (a driver or a fellow passenger) in using a display apparatus including a plurality of display units and included in an in-vehicle system.

A first aspect of the disclosure relates to an in-vehicle system. The in-vehicle system includes a display apparatus that includes a pair of first display units and a second display unit, and an information processing apparatus configured to control the display apparatus. The pair of first display units is respectively disposed at locations on both sides of a steering wheel while projecting toward a rear side of a vehicle beyond an instrument panel, and each of the pair of first display units has a touch panel. The instrument panel is disposed in front of a driver seat in a vehicle cabin and directly ahead of the steering wheel. The second display unit is disposed at an intermediate location between the driver seat and a front passenger seat in a front region of the vehicle cabin. The information processing apparatus includes a control unit configured to mirror, onto the second display unit, a screen displayed on one of the pair of first display units when a predetermined input operation is detected by the touch panel. The predetermined input operation is performed by a user on the one of the pair of first display units.

In the display apparatus of the first aspect, a size of the second display unit may be larger than a size of each of the first display units.

In the display apparatus of the first aspect, the second display unit may have a touch panel.

In the display apparatus of the first aspect, each of the pair of first display units may be configured to display an interface regarding a predetermined function of the vehicle. The interface may include an operating icon used for input operation.

In the first aspect, the predetermined input operation may be a swipe or flick toward the front passenger seat or a pinch-out.

A second aspect of the disclosure relates to a vehicle that includes the in-vehicle system according to the first aspect of the disclosure.

A third aspect of the disclosure relates to an information processing apparatus. The information processing apparatus includes a control unit configured to control a display apparatus including a pair of first display units and a second display unit. The pair of first display units is respectively disposed at locations on both sides of a steering wheel while projecting toward a rear side of a vehicle beyond an instrument panel, and each of the pair of first display units has a touch panel. The instrument panel is disposed in front of a driver seat in a vehicle cabin and directly ahead of the steering wheel. The second display unit is disposed at an intermediate location between the driver seat and a front passenger seat in a front region of the vehicle cabin. The control unit is configured to mirror, onto the second display unit, a screen displayed on one of the pair of first display units when a predetermined input operation is detected by the touch panel. The predetermined input operation is performed by a user on any one of the pair of first display units.

In the display apparatus of the third aspect, a size of the second display unit may be larger than a size of each of the first display units. The second display unit may have a touch panel.

In the display apparatus of the third aspect, each of the pair of first display units may be configured to display an interface regarding a predetermined function of the vehicle. The interface may include an operating icon used for input operation.

In the third aspect, the predetermined input operation may be a swipe or flick toward the front passenger seat or a pinch-out.

Other aspects include an information processing method executed by the information processing apparatus, a program for causing a computer to execute the information processing method, and a non-transitory computer-readable storage medium storing the program.

According to this disclosure, convenience for a user (a driver or a fellow passenger) in using the display apparatus including the plurality of display units and included in the in-vehicle system can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view that shows a state of a front part in a cabin of a vehicle according to an embodiment;

FIG. 2 is a view that shows the schematic configuration of a display apparatus and its surroundings;

FIG. 3 is a block diagram that schematically shows an example of the hardware configuration of a system mounted on the vehicle;

FIG. 4 is a block diagram that schematically shows an example of the functional configuration of an ECU;

FIG. 5 is a first view that shows an example of a plurality of interface screens displayed on an outer display;

FIG. 6 is a second view that shows an example of a plurality of interface screens displayed on the outer display;

FIG. 7 is a first view that shows an example of a plurality of interface screens displayed on an inner display;

FIG. 8 is a second view that shows an example of a plurality of interface screens displayed on the inner display;

FIG. 9 is a diagram that shows a state of the displays when a second interface displayed on the inner display is mirrored onto a center display; and

FIG. 10 is a flowchart that shows the flow of mirroring control according to the embodiment.

### DETAILED DESCRIPTION OF EMBODIMENTS

In recent years, vehicles in which a plurality of displays is provided in the front region of a vehicle cabin have been developed. In the thus configured vehicle, the display disposed in front of a driver seat in the vehicle cabin may display an interface regarding a predetermined function of the vehicle. In this case, information to be provided to a driver is output or information indicating a request from the driver is input through the interface displayed on the display.

In the above-described vehicle, a screen (interface) displayed on the display disposed in front of the driver seat may be desired to be shared with a fellow passenger other than the driver. However, the display disposed in front of the driver seat is difficult for the fellow passenger to view. Therefore, there is room for improvement in convenience for a user (a driver or a fellow passenger) in using a display apparatus that includes a plurality of display units.

In contrast, an in-vehicle system that is one aspect of this disclosure includes a display apparatus that includes a plurality of display units including a pair of first display units and a second display unit, and an information processing apparatus configured to control the display apparatus. The pair of first display units is respectively disposed at locations on both sides of a steering wheel while projecting toward a rear side of a vehicle beyond an instrument panel disposed in front of a driver seat in a vehicle cabin and directly ahead of the steering wheel, and each of the pair of first display units has a touch panel. The second display unit is disposed at an intermediate location between the driver seat and a front passenger seat in a front region of the vehicle cabin. The information processing apparatus includes a control unit configured to, when a predetermined input operation performed by a user on any one of the pair of first display units is detected by the touch panel, mirror a screen displayed on one of the pair of first display units, on which the predetermined input operation is performed, onto the second display unit.

An in-vehicle system includes a display apparatus. The display apparatus includes a plurality of display units including a pair of first display units and a second display unit. The pair of first display units is respectively disposed at locations on both sides of a steering wheel while projecting toward a rear side of a vehicle beyond an instrument panel disposed in front of a driver seat in a vehicle cabin and directly ahead of the steering wheel. In other words, at the driver seat in the vehicle cabin, each of the pair of first display units is disposed near the steering wheel. Each of the pair of first display units has a touch panel. Therefore, each of the first display units can receive an input operation (touch operation) from the driver. The second display unit is disposed at an intermediate location between the driver seat and a front passenger seat in a front region of the vehicle cabin. In other words, the second display unit is disposed in the front region of the vehicle cabin on the front passenger seat side relative to the pair of first display units.

The in-vehicle system includes an information processing apparatus. The information processing apparatus includes a control unit configured to control the display apparatus. Then, when the control unit detects that a predetermined input operation has been performed by the user on any one of the pair of first display units via the touch panel, the control unit is configured to mirror a screen displayed on one of the first display units, on which the predetermined input operation is performed, onto the second display unit. In other words, the control unit identifies which one of the pair of first display units the predetermined input operation has been performed on by the user. Furthermore, the control unit displays the same screen as the screen displayed on the first display unit, on which the predetermined input operation has been performed by the user, onto the second display unit. Here, the predetermined input operation is, for example, a swipe or flick toward the front passenger seat, or a pinch-out.

With the in-vehicle system as described above, when the screen displayed on any one of the pair of first display units disposed in front of the driver seat is desired to be shared with a fellow passenger other than the driver, the driver can easily share the target screen with a fellow passenger. Therefore, convenience for a user (a driver or a fellow passenger) in using the display apparatus including the plurality of display units can be improved.

When the size of the second display unit is larger than the size of each of the first display units, the target screen can be displayed larger by displaying the screen displayed on the first display unit, on the second display unit. When not only the first display units but also the second display unit has a touch panel, the user is able to perform input operations (touch operations) on the target screen on the second display unit by causing the second display unit to display the screen displayed on one of the first display units.

Hereinafter, a specific embodiment of the disclosure will be described with reference to the accompanying drawings. The dimensions, materials, and shapes of components described in the present embodiment, the arrangement of the components, and the like do not intend to limit the technical scope of the disclosure to them unless otherwise specified.

### Embodiment

### Schematic Configuration of System

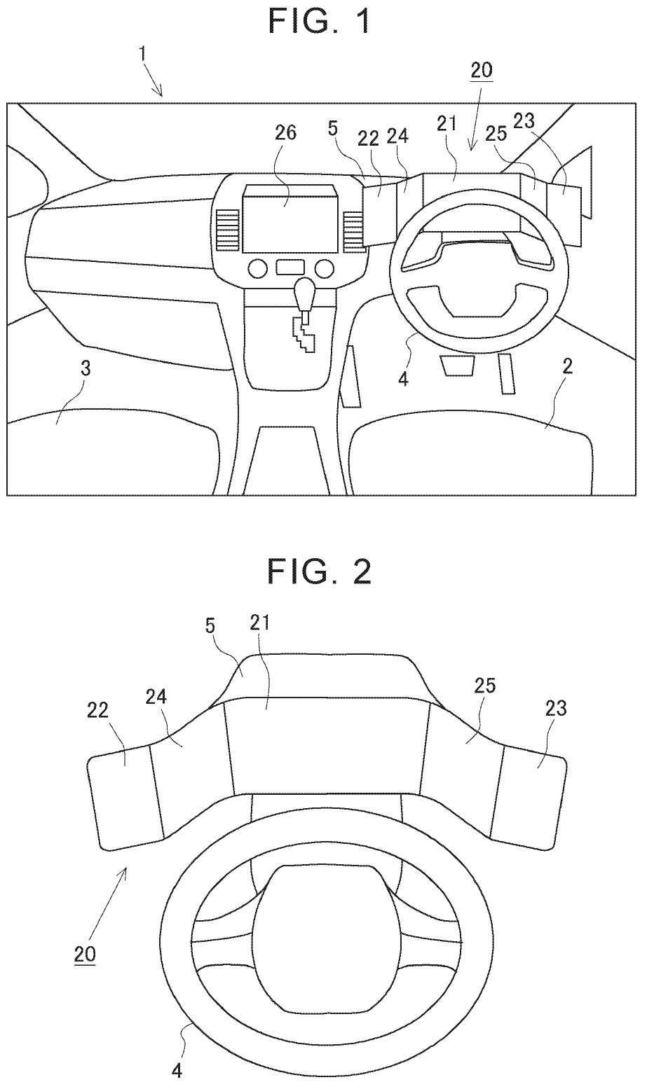

FIG. 1 is a view that shows a state of a front part in a cabin of a vehicle according to the present embodiment. A driver seat 2 and a front passenger seat 3 are provided in the cabin of the vehicle 1. The vehicle 1 of the present embodiment is a right-hand drive vehicle, and the driver seat 2 is provided on the right side of the vehicle 1 in the traveling direction. A steering wheel 4 is disposed on the front side of the driver seat 2. The steering wheel 4 may be circular or may be U-shaped (so-called a non-circular steering wheel). The steering wheel 4 is connected to a steering system of the vehicle 1 via a steering column. The steering column is covered by a column cover. In the cabin of the vehicle 1, the front passenger seat 3 is provided on the left side of the driver seat 2 (the left side of the vehicle 1 in the traveling direction).

A display apparatus 20 is provided in the front region of the cabin of the vehicle 1. The display apparatus 20 includes a plurality of displays 21, 22, 23, 26. Specifically, the display apparatus 20 includes a meter display 21, an inner display 22, an outer display 23, and a center display 26. The meter display 21 is located in front of the driver seat 2 and directly ahead of the steering wheel 4 (substantially the center at the front part of the driver seat 2). The inner display 22 is located rearward of and inward of the meter display 21 relative to the vehicle 1. The outer display 23 is located rearward of and outward of the meter display 21 relative to the vehicle 1. The inner display 22 is connected to the meter display 21 via a connecting portion 24. The outer display 23 is connected to the meter display 21 via a connecting portion 25.

The center display 26 is located at an intermediate location between the driver seat 2 and the front passenger seat 3 in the front region of the vehicle cabin (substantially the center at the front part of the cabin). In other words, the center display 26 is provided on the side closer to the front passenger seat 3 than the meter display 21, the inner display 22, and the outer display 23 in the front region of the vehicle cabin.

=Here, the outer side of the vehicle 1 refers to the side closer to the exterior of the vehicle 1 when viewed from the driver seat 2, that is, the door side of the driver seat 2. The inner side of the vehicle 1 refers to the side closer to the front passenger seat 3 when viewed from the driver seat 2, that is, the door side of the front passenger seat 3. For example, in the vehicle 1 in which the steering wheel 4 is provided on the right side of the vehicle 1, the outer side of the vehicle 1 refers to the right side of the vehicle 1, and the inner side of the vehicle 1 refers to the left side of the vehicle 1. For example, in the vehicle 1 in which the steering wheel 4 is provided on the left side of the vehicle 1, the outer side of the vehicle 1 refers to the left side of the vehicle 1, and the inner side of the vehicle 1 refers to the right side of the vehicle 1.

The meter display 21, the inner display 22, the outer display 23, and the center display 26 are all displays each of which has a touch panel. It is sufficient that at least each of the inner display 22 and the outer display 23 has a touch panel. The meter display 21, the inner display 22, and the outer display 23 may be formed by deforming a single touch screen or may be formed by combining individual touch screens.

A touch panel, such as a pressure-sensitive touch panel that detects the pressure applied by the user to the panel and a capacitive touch panel that detects changes in capacitance when the user presses the panel, can be adopted as the touch panel of each of the displays of the display apparatus 20. Each of the displays is, for example, a liquid crystal display (LCD) panel or an electro luminescence (EL) panel. In the following description, touching by the user means that the user touches the touch panel.

The center display 26 may display auxiliary information regarding driving (for example, navigation information) that is provided for the driver of the vehicle 1. The center display 26 may display information regarding entertainment, such as audio and television.

Here, a more detailed configuration of the meter display 21, inner display 22, and outer display 23 in the display apparatus 20 will be described with reference to FIG. 2. FIG. 2 is a view that shows the schematic configuration of the display apparatus 20 and its surroundings. The meter display 21 of the display apparatus 20 is fixed to an instrument panel 5. The meter display 21 is a horizontally-elongated display, while the inner display 22 and the outer display 23 are vertically-elongated displays. The meter display 21 is disposed such that the screen faces the rear of the vehicle 1 and is disposed parallel to the right and left direction (vehicle width direction) of the vehicle 1. The meter display 21 may be disposed so as to be tilted slightly upward.

One end of the connecting portion 24 is connected to the vehicle inner-side end of the meter display 21, and the inner display 22 is connected to the other end of the connecting portion 24. The inner display 22 is a display that extends from the vehicle inner-side end of the connecting portion 24 toward the rear and inner side of the vehicle 1. The angle that the inner display 22 makes with the meter display 21 is smaller than the angle that the connecting portion 24 makes with the meter display 21. The connecting portion 24 is connected to the meter display 21 and the inner display 22 while being curved. The connecting portion 24 has a curved surface that is concave toward the vehicle front side at the connection with the meter display 21 and has a curved surface that is convex toward the vehicle rear side at the connection with the inner display 22. The meter display 21 and/or the inner display 22 may have a curved surface.

One end of the connecting portion 25 is connected to the vehicle outer-side end of the meter display 21, and the outer display 23 is connected to the other end of the connecting portion 25. The outer display 23 is a display that extends from the vehicle outer-side end of the connecting portion 25 toward the rear and outer side of the vehicle 1. The angle that the outer display 23 makes with the meter display 21 is smaller than the angle that the connecting portion 25 makes with the meter display 21. The connecting portion 25 is connected to the meter display 21 and the outer display 23 while being curved. The connecting portion 25 has a curved surface that is concave toward the vehicle front side at the connection with the meter display 21 and has a curved surface that is convex toward the vehicle rear side at the connection with the outer display 23. The meter display 21 and/or the outer display 23 may have a curved surface.

The steering wheel 4 includes holding portions that are portions gripped by the driver. In the display apparatus 20, when the meter display 21, the inner display 22, the outer display 23, and the connecting portions 24, 25 have the shapes described above, the inner display 22 and the outer display 23 are respectively disposed near the holding portions of the steering wheel 4.

The inner display 22 and the outer display 23 are angled relative to the right and left direction of the steering wheel 4. Each of the inner display 22 and the outer display 23 is disposed so as to tilt toward the steering wheel 4. In other words, the inner display 22 projects toward the rear side of the vehicle 1 as it approaches the inner side of the vehicle 1, and the outer display 23 is disposed so as to project toward the rear side of the vehicle 1 as it approaches the outer side of the vehicle 1. In this way, each of the inner display 22 and the outer display 23 is disposed so as to face the driver.

The meter display 21 displays an interface that shows information used for driving the vehicle 1, such as the speed, engine rotation speed (when the vehicle 1 includes an engine), charge and discharge status (when the vehicle 1 includes a drive battery), travel distance, and status of an advanced driver-assistance systems (ADAS) of the vehicle 1.

The outer display 23 displays interfaces (hereinafter, which may be referred to as “first interfaces”) regarding a plurality of first predetermined functions among a plurality of functions of the vehicle 1. Here, the first predetermined functions include functions related to control of the vehicle 1. The inner display 22 displays interfaces (hereinafter, which may be referred to as “second interfaces”) regarding a plurality of second predetermined functions different from the first predetermined functions among the functions of the vehicle 1. Here, the second predetermined functions include functions related to convenience for an occupant of the vehicle 1. Each of the first interfaces displayed on the outer display 23 and each of the second interfaces displayed on the inner display 22 include operating icons (for example, switch icons or button icons) that are operated by the driver of the vehicle 1. The details of the first predetermined functions, the second predetermined functions, the first interfaces, and the second interfaces will be described later.

As described above, the display apparatus 20 is configured such that the inner display 22 and the outer display 23 are paired in consideration of ease of operation for the driver. In the display apparatus 20, the size of the center display 26 is larger than the size of the inner display 22. The size of the center display 26 is larger than the size of the outer display 23. In the present embodiment, the meter display 21 is an example of the instrument panel according to the disclosure. In the present embodiment, the inner display 22 and the outer display 23 are examples of the first display units according to the disclosure. In the present embodiment, the center display 26 is an example of the second display unit according to the disclosure.

### Hardware Configuration

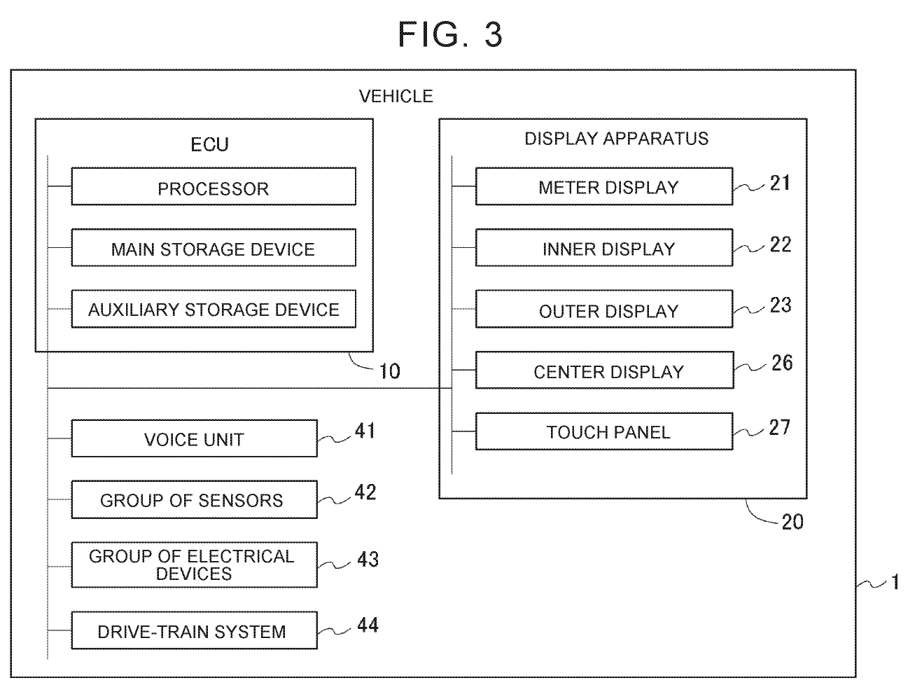

FIG. 3 is a block diagram that schematically shows an example of the hardware configuration of a system mounted on the vehicle 1. The system mounted on the vehicle 1 includes an ECU 10, the display apparatus 20, a voice unit 41, a group of sensors 42, a group of electrical devices 43, and a drive-train system 44.

The ECU 10 can be configured as a computer that includes a processor (such as a CPU and a GPU), a main storage device (such as a RAM and a ROM), and an auxiliary storage device (such as an EPROM, a hard disk drive, and a removable medium). An operating system (OS), various programs, various tables, and the like, are stored in the auxiliary storage device. Various functions (software modules) that match predetermined purposes as will be described later can be implemented by running the programs stored in the auxiliary storage device. One, some, or all of the functions may be implemented as hardware modules by a hardware circuit, such as an ASIC and an FPGA. The display apparatus 20, the voice unit 41, the group of sensors 42, the group of electrical devices 43, and the drive-train system 44 are connected to the ECU 10. The ECU 10 does not necessarily need to be made up of a single hardware component and may be made up of a plurality of computers. In the present embodiment, the ECU 10 is an example of the information processing apparatus according to the disclosure.

The display apparatus 20 includes the meter display 21, the inner display 22, the outer display 23, the center display 26, and touch panels 27. The touch panels 27 are units for detecting touch operations performed on the meter display 21, the inner display 22, the outer display 23, and the center display 26. The touch panels 27 are respectively disposed on the meter display 21, the inner display 22, the outer display 23, and the center display 26. Thus, each display is configured to be operable by touching. The meter display 21, the inner display 22, the outer display 23, the connecting portions 24, 25, and the touch panels 27 may be configured by deforming the shape of a single touch screen.

The voice unit 41 is a unit that performs input and output of information by voice. The voice unit 41 may include, for example, a speaker and a microphone. The voice unit 41 is capable of capturing voice produced by an occupant of the vehicle 1. The voice unit 41 is capable of emitting voice to an occupant of the vehicle 1.

The group of sensors 42 is a collection of a plurality of sensors for acquiring sensor data used in driving the vehicle 1. The sensors may be the ones that acquire physical quantities or the ones that acquire image data and the like. The group of sensors 42 includes, for example, sensors that detect the states of the vehicle 1, sensors that detect the actions of the driver, and the like. Specifically, the group of sensors 42 may include a speed sensor, an acceleration sensor, an accelerator operation amount sensor, a brake sensor, a steering angle sensor, an engine rotation speed sensor, a yaw rate sensor, a turn signal switch sensor, a shift position sensor, a GPS sensor, an interior temperature sensor, an outside air temperature sensor, a distance measuring radar, an illuminance sensor, and the like.

The speed sensor detects the speed of the vehicle 1. The acceleration sensor detects the acceleration of the vehicle 1. The accelerator operation amount sensor detects the position of an accelerator pedal. The brake sensor detects the position of a brake pedal. The steering angle sensor detects the steering angle of the steering wheel 4. The engine rotation speed sensor detects the rotation speed of the engine. The yaw rate sensor detects the yaw rate of the vehicle 1. The turn signal switch sensor detects the status of the switch of a turn-signal light. The shift position sensor detects the shift position. The GPS sensor acquires the location information of the vehicle 1. The interior temperature sensor detects the interior temperature. The outside air temperature sensor detects the outside air temperature. The distance measuring radar measures the distance to an object. The illuminance sensor detects the brightness of an environment outside of the vehicle 1.

The group of electrical devices 43 is a collection of electrical devices provided in the vehicle 1. The group of electrical devices 43 includes vehicle control system devices, such as a headlight unit, a wiper actuator, a mirror actuator, and a seat actuator. The group of electrical devices 43 further includes in-vehicle apparatuses having functions other than vehicle control, such as a navigation system, a multimedia device, and an air conditioner.

The drive-train system 44 is a system made up of drive-train devices of the vehicle 1. The drive-train devices include, for example, the engine and/or a motor serving as a power source, a battery, and a transmission.

### Functional Configuration of ECU

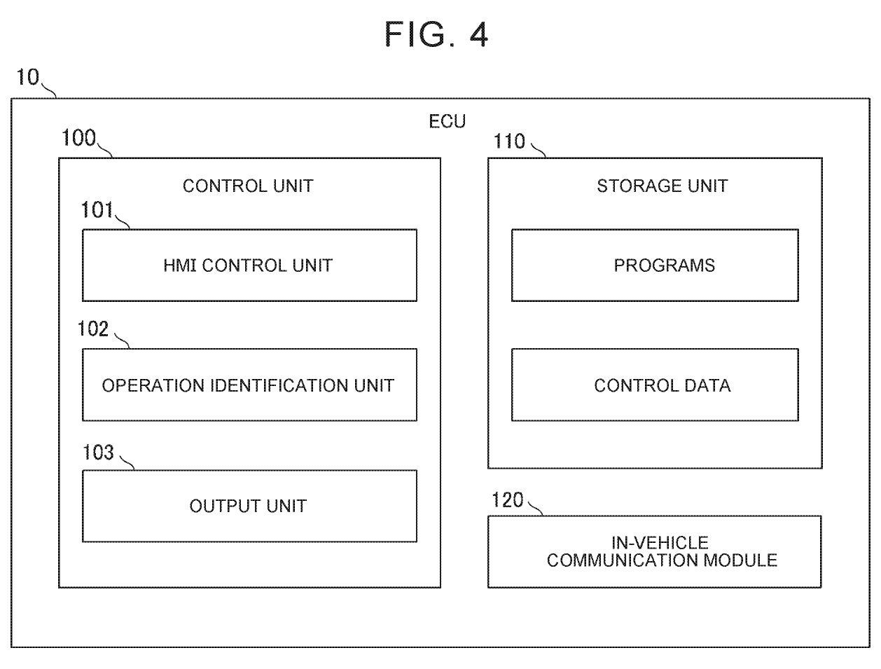

Here, the functional configuration of the ECU 10 will be described with reference to FIG. 4. FIG. 4 is a block diagram that schematically shows an example of the functional configuration of the ECU. The ECU 10 includes a control unit 100, a storage unit 110, and an in-vehicle communication module 120 as functional component elements. The control unit 100 is, for example, a functional component element provided by the processor running various programs stored in the auxiliary storage device. The display apparatus 20 receives a control instruction via any one of the touch panels 27 from the user that is an occupant of the vehicle 1. At this time, a signal corresponding to an input operation on any of the displays 21, 22, 23, 26 by the user is transmitted from a corresponding one of the touch panels 27 to the ECU 10. Then, in the ECU 10, the control unit 100 executes control of the display apparatus 20, the electrical devices included in the group of electrical devices 43, or the drive-train devices included in the drive-train system 44, in response to the input operation on any one of the displays by the user.

The control unit 100 includes a human machine interface (HMI) control unit 101, an operation identification unit 102, and an output unit 103 as software modules. The HMI control unit 101 generates interfaces regarding various functions of the vehicle 1. Furthermore, the HMI control unit 101 displays the generated interfaces respectively on the displays of the display apparatus 20. Each of the interfaces generated by the HMI control unit 101 and respectively displayed on the displays includes operating icons that can be operated by the user. The operating icons are icons that allow the driver to control various functions of the vehicle 1. The HMI control unit 101 receives control instructions input when the user operates the operating icons.

The operation identification unit 102 identifies the input operation of the user on any one of the displays based on a signal received from the corresponding touch panel 27 of the display apparatus 20. For example, the operation identification unit 102 identifies the location touched by the user on any one of the displays 21, 22, 23, 26 of the display apparatus 20. The operation identification unit 102 identifies the operation details of the input operation (such as flick, swipe, tap, pinch, double tap, long tap, and multi-tap) performed by the user on any one of the displays 21, 22, 23, 26 of the display apparatus 20.

The output unit 103 transmits a control signal corresponding to the control instruction received by the HMI control unit 101 or the input operation of the user, identified by the operation identification unit 102, to devices to be controlled (that is, any one of the display apparatus 20, the electrical devices included in the group of electrical devices 43, or the drive-train devices included in the drive-train system 44). In the devices to be controlled, the control signal transmitted by the output unit 103 is received, and control according to the control signal is executed. When, for example, the user performs a predetermined input operation on the inner display 22 or the outer display 23, the output unit 103 transmits a control signal for mirroring to the display apparatus 20. Here, mirroring is control to cause the center display 26 to display the same screen as the screen displayed on one of the inner display 22 and the outer display 23, on which the user has performed the predetermined input operation. The details of such mirroring control will be described later.

The storage unit 110 is a functional component element that stores information. The storage unit 110 is configured to include the main storage device and the auxiliary storage device. The storage unit 110 stores various programs to be run by the control unit 100, and control data used to run the various programs.

The in-vehicle communication module 120 is a functional component element for connecting the ECU 10 to a vehicle network using a predetermined in-vehicle communication standard. A controller area network (CAN), a local interconnect network (LIN), or the like, can be illustrated as the predetermined in-vehicle communication standard. The ECU 10 communicates with various devices provided in the vehicle 1 via the in-vehicle communication module 120.

### Interfaces

Next, the interfaces displayed on the inner display 22 and outer display 23 of the display apparatus 20 will be described. As described above, the HMI control unit 101 displays a plurality of interfaces regarding various functions of the vehicle 1 respectively on the displays of the display apparatus 20. At this time, the HMI control unit 101 displays the first interface regarding the first predetermined function (a function related to control of the vehicle 1) on the outer display 23. The HMI control unit 101 also displays the second interface regarding the second predetermined function (a function related to convenience for an occupant of the vehicle 1) on the inner display 22.

In the display apparatus 20, the output destinations of the plurality of interfaces regarding various functions of the vehicle 1 are allocated according to the type of function as described above. As a result, the driver easily intuitively recognizes which one of the inner display 22 and the outer display 23 the interface that the driver desires to check or operate the display details is output to, by him or herself. The operating surface of the touch panel 27 of each of the inner display 22 and the outer display 23 is disposed near the steering wheel 4. As a result, when the driver attempts to execute various control by performing a touch operation on the display, the movement of their gaze and hand of the driver can be minimized.

One of the first interfaces is displayed on the outer display 23. One of the second interfaces is displayed on the inner display 22. Then, the first interface displayed on the outer display 23 and the second interface displayed on the inner display 22 are switched by the HMI control unit 101. The driver of the vehicle 1 is able to switch the view on each display by performing a predetermined operation, such as a left or right swipe, on the touch panel 27 of the inner display 22 or the outer display 23.

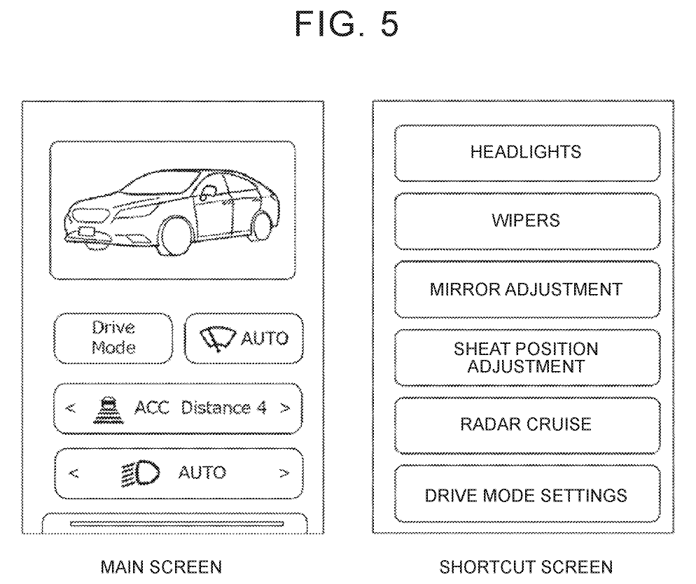

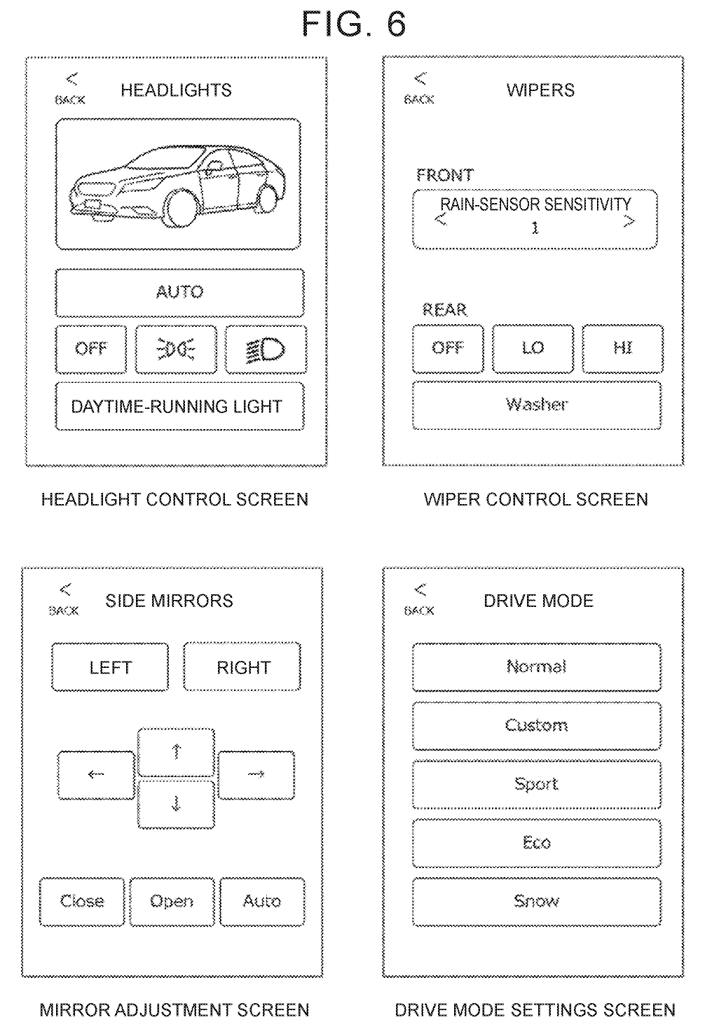

Here, the interface displayed on the outer display 23 will be described with reference to FIG. 5 and FIG. 6. FIG. 5 and FIG. 6 are views that show examples of a plurality of interface screens displayed as the first interface on the outer display 23 by the HMI control unit 101. As shown in FIG. 5, a main screen and a shortcut screen are displayed on the outer display 23.

### Main Screen

The main screen is an interface screen that is normally displayed on the outer display 23 while the vehicle 1 is being driven. The main screen displays operating icons regarding frequently used functions. The display details of the main screen can be customized by the user.

### Shortcut Screen

The shortcut screen is an interface screen for jumping to each interface screen that is displayed on the outer display 23 as the first interface, as will be described later. The shortcut screen includes operating icons for jumping to each interface screen that can be displayed on the outer display 23. When the driver selects one of the pluralities of operating icons included in the shortcut screen and operates the operating icon, the view on the outer display 23 transitions to the interface screen regarding the function corresponding to the selected operating icon.

As shown in FIG. 6, a headlight control screen, a wiper control screen, a mirror adjustment screen, and a drive mode settings screen are displayed on the outer display 23 as the first interface.

### Headlight Control Screen

The headlight control screen is an interface screen regarding a headlight control function. The headlight control screen includes operating icons for setting the status of the headlights of the vehicle 1 (automatic, on, off, small light, daytime running light, or the like). Then, based on the operations performed by the driver on the headlight control screen, the control unit 100 controls the headlight unit included in the group of electrical devices 43. The current status of the headlights is displayed on the headlight control screen.

### Wiper Control Screen

The wiper control screen is an interface screen regarding a wiper control function. The wiper control screen includes operating icons for setting the operational statuses (stop, automatic operation, intermittent operation, continuous operation, or the like) of the wipers (a front wiper and a rear wiper) of the vehicle 1. Then, based on the operations performed by the driver on the wiper control screen, the control unit 100 controls wiper actuators included in the group of electrical devices 43. The current operational statuses of the front wiper and the rear wiper are displayed on the wiper control screen.

### Mirror Adjustment Screen

The mirror adjustment screen is an interface screen regarding a mirror adjustment function. The mirror adjustment screen includes operating icons for adjusting the state (retracted or deployed state and angle) of the side mirrors of the vehicle 1. Then, based on the operations performed by the driver on the mirror adjustment screen, the control unit 100 controls the mirror actuators included in the group of electrical devices 43. The current state of the side mirrors is displayed on the mirror adjustment screen.

### Drive Mode Settings Screen

The drive mode settings screen is an interface screen regarding a drive mode setting function. The drive mode settings screen includes operating icons for setting the drive mode of the vehicle 1. Then, based on the operations performed by the driver on the drive mode settings screen, the control unit 100 sets the drive mode.

All the above-described headlight control function, wiper control function, mirror adjustment function, and drive mode setting function are types of the first predetermined function. However, the first predetermined function is not limited to these functions. For example, a seat position adjustment function and an ADAS setting function are also types of the first predetermined function. The seat position adjustment function enables the control unit 100 to adjust the positions and angles of the seats provided in the vehicle 1 by controlling the seat actuators. The ADAS setting function enables the control unit 100 to control the ADAS of the vehicle 1. Then, the seat position adjustment screen and the ADAS settings screen may be displayed on the outer display 23 as the first interfaces. The seat position adjustment screen is an interface screen regarding the seat position adjustment function. The ADAS settings screen is an interface screen regarding the ADAS setting function.

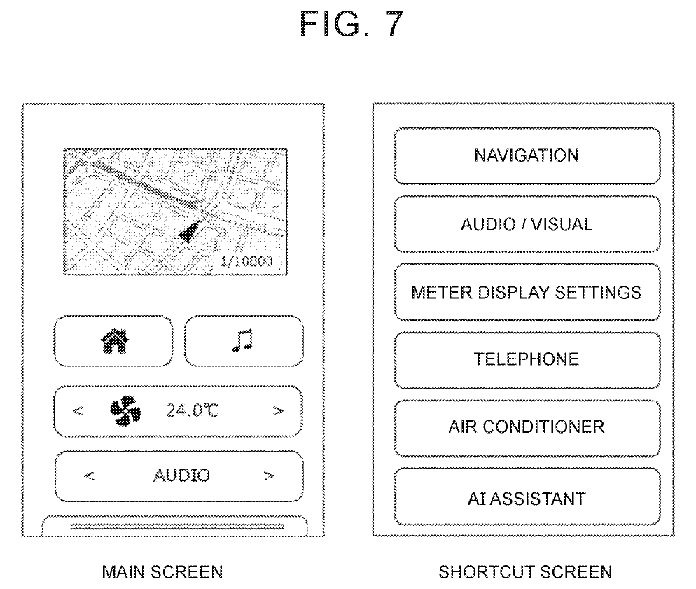

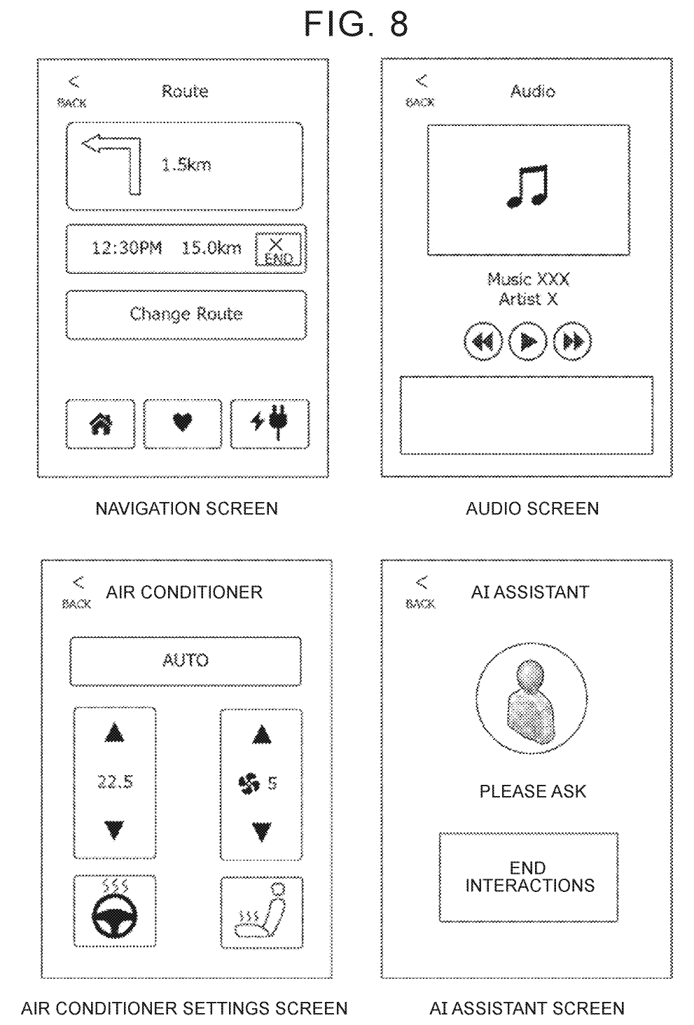

Next, the interface displayed on the inner display 22 will be described with reference to FIG. 7 and FIG. 8. FIG. 7 and FIG. 8 are views that show examples of a plurality of interface screens displayed as the second interface on the inner display 22 by the HMI control unit 101. As shown in FIG. 7, a main screen and a shortcut screen are displayed on the inner display 22.

### Main Screen

The main screen is an interface screen that is normally displayed on the inner display 22 while the vehicle 1 is being driven. The main screen displays operating icons regarding frequently used functions. The display details of the main screen can be customized by the user.

### Shortcut Screen

The shortcut screen is an interface screen for jumping to each interface screen that is displayed on the inner display 22 as the second interface, as will be described later. The shortcut screen includes operating icons for jumping to each interface screen that can be displayed on the inner display 22. When the driver selects one of the pluralities of operating icons included in the shortcut screen and operates the operating icon, the view on the inner display 22 transitions to the interface screen regarding the function corresponding to the selected operating icon.

As shown in FIG. 8, a navigation screen, an audio screen, an air conditioner settings screen, and an AI assistant screen are displayed on the inner display 22 as the second interfaces.

### Navigation Screen

The navigation screen is an interface screen regarding a navigation function. Information regarding navigation, generated by the control unit 100, is displayed on the navigation screen. The navigation screen includes operating icons for destination setting, location registration, and the like.

### Audio Screen

The audio screen is an interface screen regarding an audio function of the multimedia device. The audio screen includes operating icons for controlling the audio function of the multimedia device (such as playback of music). Then, based on the operations performed by the driver on the audio screen, the control unit 100 controls the multimedia device included in the group of electrical devices 43. Information regarding the music being played is displayed on the audio screen.

### Air Conditioner Settings Screen

The air conditioner settings screen is an interface screen regarding an air conditioner control function. The air conditioner settings screen includes operating icons for setting the operational status (such as temperature, airflow, and air conditioning function) of an air conditioner. Then, based on the operations performed by the driver on the air conditioner settings screen, the control unit 100 controls the air conditioner included in the group of electrical devices 43. The current operational status of the air conditioner is displayed on the air conditioner settings screen.

### AI Assistant Screen

The AI assistant screen is an interface screen regarding an agent function. The AI assistant screen is a screen for interacting with a virtual agent (AI assistant) capable of natural-language dialogue. The AI assistant screen includes a character of a virtual agent. The user is able to obtain information by interacting with the character on the AI assistant screen. A natural-language dialogue service is provided by the control unit 100. The AI assistant screen includes operating icons for interacting with the AI assistant.

All the above-described navigation function, audio function, air conditioner control function, and agent function are types of the second predetermined function. However, the second predetermined function is not limited to these functions. For example, a telephone function is also a type of the second predetermined function. The telephone function enables the control unit 100 to wirelessly connect to a user terminal in the vehicle 1 to achieve hands-free calling by controlling the wireless communication function of the multimedia device. Then, a call screen is displayed on the inner display 22 as the second interface. The call screen is an interface screen regarding the telephone function.

### Mirroring Control

The display apparatus 20 according to the disclosure is configured to be capable of mirroring control. Mirroring control is control to mirror the screen displayed on the inner display 22 or the screen displayed on the outer display 23 onto the center display 26. For example, as described above, the second interface regarding the second predetermined function that is a function related to convenience for an occupant of the vehicle 1 is displayed on the inner display 22. Operations on the second interface may be desired to be performed by a fellow passenger instead of the driver of the vehicle 1. In such cases, when the driver performs a predetermined input operation on the inner display 22, the second interface displayed on the inner display 22 is mirrored onto the center display 26.

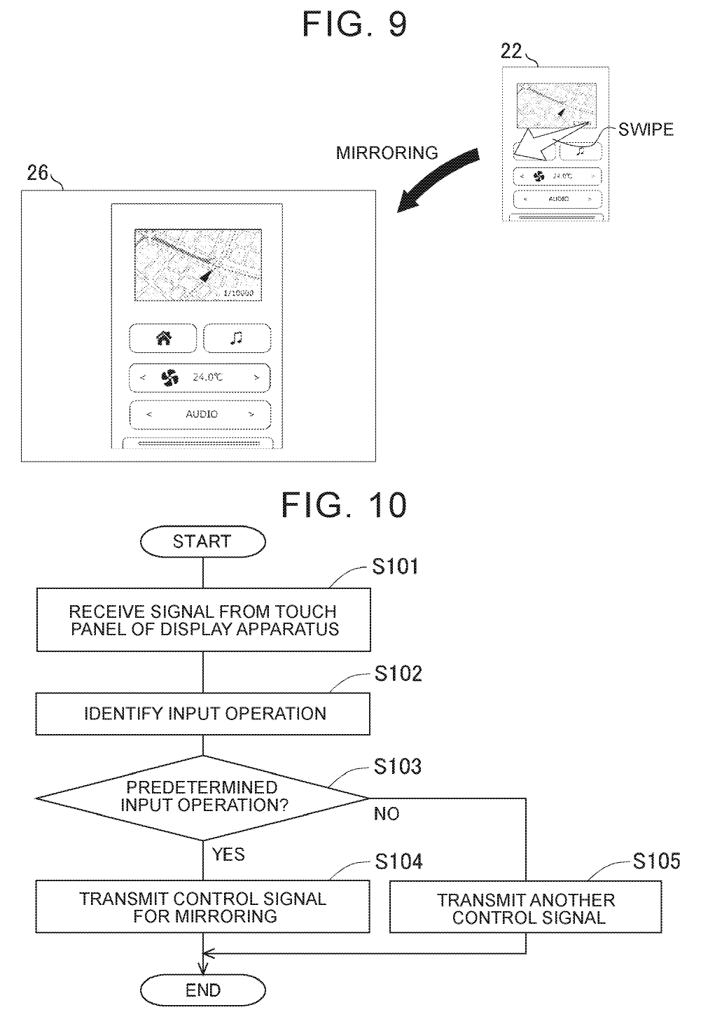

FIG. 9 is a diagram that shows a state of the displays when the second interface displayed on the inner display 22 is mirrored onto the center display 26. Here, the predetermined input operation performed by the driver on the inner display 22 may be, for example, a swipe toward a side where the center display 26 is disposed, that is, toward the front passenger seat. In FIG. 9, while the main screen shown in FIG. 7 is displayed on the inner display 22, the predetermined input operation (swipe) is performed on the inner display 22. As a result, as shown in FIG. 9, the main screen on the inner display 22 is mirrored onto the center display 26. In other words, the same screen as the main screen on the inner display 22 is displayed on the center display 26.

As described above, when the same screen as the main screen on the inner display 22 is displayed on the center display 26, the fellow passenger is able to view the display details on the inner display 22 through the center display 26. In the display apparatus 20, the center display 26 also has the touch panel 27. Therefore, when the main screen on the inner display 22 is displayed on the center display 26, the fellow passenger is able to operate the main screen on the inner display 22.

When a predetermined input operation is performed on the inner display 22 while a screen other than the main screen is displayed on the inner display 22 as well, the same screen as the screen (interface) displayed on the inner display 22 is displayed on the center display 26 similarly to the above. Therefore, the fellow passenger is able to perform, via the center display 26, various operations that have been performed by the driver through the inner display 22. Specifically, the operations for navigation, which have been performed on the navigation screen, the interactions with the AI assistant, which have been performed on the AI assistant screen, or the like, can be taken over from the driver and performed by the fellow passenger.

The screen mirrored onto the center display 26 is not limited to the screen displayed on the inner display 22. In other words, when a predetermined input operation is performed on the outer display 23, the same screen as the screen (interface) displayed on the outer display 23 is displayed on the center display 26.

Mirroring of the screen displayed on the inner display 22 or the screen displayed on the outer display 23 onto the center display 26 is not necessarily performed when there is a fellow passenger other than the driver in the vehicle 1. In other words, even in a situation where there is no fellow passenger in the vehicle 1, such mirroring as described above may be performed.

Here, the size of the center display 26 is larger than the size of the inner display 22 and also larger than the size of the outer display 23. Therefore, when the screen displayed on the inner display 22 or the screen displayed on the outer display 23 is mirrored onto the center display 26, these screens can be displayed in a larger size. For this reason, even when such mirroring as described above is performed while there is no fellow passenger in the vehicle 1, the effect of making it possible for the driver to view the screen displayed on the inner display 22 or the screen displayed on the outer display 23 as a screen in a larger size can be obtained.

A predetermined input operation performed on the inner display 22 or the outer display 23 for mirroring onto the center display 26 is not limited to a swipe toward the front passenger seat. A predetermined input operation may be a flick toward the front passenger seat. Alternatively, a predetermined input operation may be a pinch-out. With these input operations, the driver can mirror the screen displayed on the inner display 22 or the screen displayed on the outer display 23 onto the center display 26 by intuitive operations.

### Control Flow

Hereinafter, the flow of mirroring control will be described with reference to FIG. 10. FIG. 10 is a flowchart that shows the flow of mirroring control according to the present embodiment. This flow is executed by the control unit 100 of the ECU 10.

In this flow, initially, in S101, the control unit 100 receives a signal corresponding to an input operation by the user, transmitted from any one of the touch panels 27 of the display apparatus 20. Subsequently, in S102, the control unit 100 identifies the input operation by the user on any one of the displays 21, 22, 23, 26 of the display apparatus 20 based on the signal received in S101. As described above, the process of S102 is executed by the operation identification unit 102.

Subsequently, in S103, the control unit 100 determines whether the input operation by the user, identified in S102, is a predetermined input operation on the inner display 22 or the outer display 23. When the determination is negative in S103, control requested by the user via the display apparatus 20 can be determined as control other than mirroring control. In this case, subsequently, the process of S105 is executed. In S105, the control unit 100 transmits a control signal for executing control (other than mirroring control) according to the details of control instruction received from the user by the display apparatus 20 to the devices to which the control instruction is transmitted. After that, the execution of this flow is once ended.

On the other hand, when the determination is affirmative in S103, the process of S104 is subsequently executed. In S104, the control unit 100 transmits a control signal for mirroring to the display apparatus 20. In other words, the control unit 100 transmits, to the display apparatus 20, a control signal for causing the same screen as the screen displayed on one of the inner display 22 and the outer display 23, where the control unit 100 has determined in S102 that the predetermined input operation has been performed by the user on the center display 26. As a result, mirroring is performed in the display apparatus 20. After that, the execution of this flow is once ended.

With the above-described control flow, when the driver performs a predetermined input operation on the inner display 22 or the outer display 23, the same screen as the screen displayed on the inner display 22 or the outer display 23 can be displayed on the center display 26.

### Other Embodiments

The above-described embodiment is only illustrative, and the disclosure can be implemented with modifications as needed without departing from the purport of the disclosure. The processes and devices described in the disclosure may be freely implemented in combination without any technical contradiction.

A process described as the one that is performed by a device may be shared and performed by multiple devices. Alternatively, processes described as the ones that are respectively performed by different devices may be performed by a single device. In a computer system, what hardware configuration (server configuration) implements functions may be flexibly changed.

The disclosure may also be implemented as follows. A computer is supplied with a computer program having the functions described in the above-described embodiment, and one or more processors of the computer read out and run the program. Such a computer program may be provided to a computer with a non-transitory computer-readable storage medium connectable to a system bus of the computer or may be provided to a computer via a network. Examples of the non-transitory computer-readable storage medium include a disk or disc of any type, such as a magnetic disk (floppy (registered trademark) disk, a hard disk drive (HDD), or the like), an optical disc (CD-ROM, DVD disc, a Blue-ray disc, or the like), a read only memory (ROM), a random access memory (RAM), an EPROM, an EEPROM, a magnetic card, a flash memory, an optical card, and a medium of any type suitable for storing electronic instructions.

What is claimed is:

1. An in-vehicle system comprising:
a display apparatus that includes a pair of first display units and a second display unit; and
an information processing apparatus configured to control the display apparatus, wherein
the pair of first display units is respectively disposed at locations on both sides of a steering wheel while projecting toward a rear side of a vehicle beyond an instrument panel, and each of the pair of first display units has a touch panel, the instrument panel being disposed in front of a driver seat in a vehicle cabin and directly ahead of the steering wheel;
the second display unit is disposed at an intermediate location between the driver seat and a front passenger seat in a front region of the vehicle cabin; and
the information processing apparatus includes a control unit configured to mirror, onto the second display unit, a screen displayed on one of the pair of first display units when a predetermined input operation is detected by the touch panel, the predetermined input operation being performed by a user on the one of the pair of first display units.

2. The in-vehicle system according to claim 1, wherein, in the display apparatus, a size of the second display unit is larger than a size of each of the first display units.

3. The in-vehicle system according to claim 1, wherein, in the display apparatus, the second display unit has a touch panel.

4. The in-vehicle system according to claim 3, wherein, in the display apparatus, each of the pair of first display units is configured to display an interface regarding a predetermined function of the vehicle, the interface including an operating icon used for input operation.

5. The in-vehicle system according to claim 1, wherein the predetermined input operation is a swipe or flick toward the front passenger seat or a pinch-out.

6. A vehicle comprising the in-vehicle system according to claim 1.

7. An information processing apparatus comprising a control unit configured to control a display apparatus including a pair of first display units and a second display unit, wherein
the pair of first display units is respectively disposed at locations on both sides of a steering wheel while projecting toward a rear side of a vehicle beyond an instrument panel, and each of the pair of first display units has a touch panel, the instrument panel being disposed in front of a driver seat in a vehicle cabin and directly ahead of the steering wheel;
the second display unit is disposed at an intermediate location between the driver seat and a front passenger seat in a front region of the vehicle cabin; and
the control unit is configured to mirror, onto the second display unit, a screen displayed on one of the pair of first display units when a predetermined input operation is detected by the touch panel, the predetermined input operation being performed by a user on the one of the pair of first display units.

8. The information processing apparatus according to claim 7, wherein:
in the display apparatus, a size of the second display unit is larger than a size of each of the first display units; and
the second display unit has a touch panel.

9. The information processing apparatus according to claim 8, wherein, in the display apparatus, each of the pair of first display units is configured to display an interface regarding a predetermined function of the vehicle, the interface including an operating icon used for input operation.

10. The information processing apparatus according to claim 7, wherein the predetermined input operation is a swipe or flick toward the front passenger seat or a pinch-out.
